(19) United States
(12) Patent Application Publication
(10) Pub. No.: US 2020/0106792 A1
(43) Pub. Date: Apr. 2, 2020

(54) METHOD AND SYSTEM FOR PENETRATION TESTING CLASSIFICATION BASED ON CAPTURED LOG DATA

(71) Applicant: Circadence Corporation, Boulder, CO (US)

(72) Inventors: Janelle Louie, San Diego, CA (US); Jennifer Flynn, San Diego, CA (US); Joshua Moore, Pine, CO (US); Brendan Homnick, San Diego, CA (US); Steven Fines, San Diego, CA (US); Ashton Mozano, San Diego, CA (US); Sean White, San Diego, CA (US)

(21) Appl. No.: 16/163,954

(22) Filed: Oct. 18, 2018

Related U.S. Application Data
(60) Provisional application No. 62/574,637, filed on Oct. 19, 2017.

(51) Int. Cl. H04L 29/06; G06N 20/00; G06F 16/35

(52) U.S. Cl. CPC H04L 63/1425; G06F 16/35; G06N 20/00; H04L 63/1483

(57) ABSTRACT

Aspects of the invention comprise methods and systems for collecting penetration tester data, i.e. data from one or more simulated hacker attacks on an organization's digital infrastructure in order to test the organization's defenses, and utilizing the data to train machine learning models which aid in documenting tester training session work by automatically logging, classifying or clustering engagements or parts of engagements and suggesting commands or hints for an tester to run during certain types of engagement training exercises, based on what the system has learned from previous tester activities, or alternatively classifying the tools used by the tester into a testing tool type category.

### RELATED APPLICATION DATA

This application is a non-provisional of and claims priority to U.S. Provisional Application Ser. No. 62/574,637, filed Oct. 19, 2017. Said prior application is incorporated by reference herein in its entirety.

### FIELD OF THE INVENTION

The present invention relates to cyber penetration testing, including “Red Team” testing.

### BACKGROUND OF THE INVENTION

Attacks on computer systems are becoming more frequent and the attackers are becoming more sophisticated. These attackers generally exploit security weaknesses or vulnerabilities in these systems in order to gain access to them. However, access may even be gained because of risky or improper end-user behavior.

Organizations which have or operate computer systems may employ penetration testing (a “pen test”) in order to look for system security weaknesses. These pen tests are authorized simulated system attacks and other evaluations of the system which are conducted to determine the security of the system, including to look for security weaknesses.

Pen testing may take various forms. For example, one type of penetration testing is “red-team” testing. In this testing, a group of white-hat hackers may test an organization's defenses, including to determine vulnerabilities to the organization's system. Of course, penetration testing might be conducted by an individual and may have various levels of complexity.

One commonality to existing penetration testing is that it is generally manually executed. One or more testers manually execute (via their computer(s)) attacks on the target system. Of course, this has a number of drawbacks including that the penetration testing may be slow, may not always be consistently implemented, may not be adequately recorded and the like.

Some attempts have been made to at least partially automate aspects of pen testing. For example, REDSystems using data models to automatically generate exploits (e.g. DeepHack in Def Con 25, Mayhem from DARPA cyber grand challenge) exist, however these systems lack the disclosed functionality. One such model known as DeepHack learns to generate exploits but acquired its training data from variations on tools such as sqlmap. The disclosed invention provides the ability to source training data and labels from human testers on an ongoing basis and use Machine Learning functionality to create dynamic models based on the action of the trainers and trainees during cyber attack training sessions.

Prior art systems incorporating exploit generation only work on program binaries and do not extend to the full scope of an engagement based on a tester's real-time activity.

Other prior art platforms for Red Teaming testers such as Cobalt Strike have reporting features, but the reports lack Machine Learning functionality to classify or cluster commands that a tester has entered during a training session.

Additionally, prior art systems lack the mechanisms to aid the tester in his or her work in actually going through an engagement by suggesting commands to enter during a training session. For example, the product Faraday does not utilize Machine Learning or related functionality for classifications or other aspects of report generation.

Additionally, prior art systems lack the mechanisms to allow classification or labeling of a type (or types) of a tool which a tester is using in his or her work during a penetration testing session. Such classification would allow evaluators to easily see which types of tools are being used by the penetration testers.

Therefore, it would be advantageous if a system and method could be developed to allow such classification or labeling of a type of a tool which a tester is using in his or her work during a penetration testing session.

### SUMMARY OF THE INVENTION

One aspect of the invention relates to a system incorporating a plurality of methods to collect and use crowd-sourced penetration tester data, i.e. data from one or more hackers that attack an organization's digital infrastructure as an attacker would in order to test the organization's defenses, and tester feedback to train machine learning models which further aid in documenting their training session work by automatically logging, classifying or clustering engagements or parts of engagements and suggest commands or hints for an tester to run during certain types of engagement training exercises, based on what the system has learned from previous tester training activities.

Another aspect of the invention is a system which automatically builds models able to operate autonomously and perform certain penetration testing activities, allowing testers to narrow their focus to efforts on tasks which only humans can perform, thus creating a dynamic and focused system driven training environment.

Another aspect of the invention is systems and methods configured for classifying unknown cybersecurity tools used in penetration testing based upon monitored penetration testing of a penetration tester testing a target computing system using at least one penetration testing tool. The method captures raw log data associated with the penetration testing relative to the target computing system, parsing the raw log data into a graph having nodes, each node corresponding to an actor or a resource in the raw log data, connects the nodes with edges, each of the edges corresponding to an action of the actor or resource in the raw log data, determines features of the nodes and edges from the graph, and classifies the nodes of the graph into one or more of a plurality of testing tool type categories used in the penetration testing based on the determined features of the nodes and edges.

Further objects, features, and advantages of the present invention over the prior art will become apparent from the detailed description of the drawings which follows, when considered with the attached figures.

### DESCRIPTION OF THE DRAWINGS

FIG. 1 is a system architecture overview illustrating the relationship between tester VMs with the GUI (blow up), target machine(s), and the server where the database, scripts for processing and modeling and models reside in accordance with embodiments of the invention.

FIG. 2 is a model function overview with a flow chart of data to train model and the functions of the model in accordance with embodiments of the invention.

FIG. 3 is a system flowchart for the classification of documentation in accordance with embodiments of the invention.

FIG. 4 is a system flow chart for creating new models in accordance with embodiments of the invention.

FIG. 5 is a system flow chart for assisted attack generation in accordance with embodiments of the invention.

FIG. 6 is a graph in accordance with embodiments of the invention.

FIG. 7 is a flowchart in accordance with embodiments of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a system which creates an environment for aiding cyber penetration testing (including Red Team) activities and crowd-sourcing of offensive security tradecraft and methods for automating aspects of network security evaluations. In a preferred embodiment, this environment consists of a set of tester virtual machines (VMs) running Kali Linux or similar digital forensics and penetration testing distributions, all connected to one or more physical server(s) which can host and provide the computing power to process large amounts of data and perform machine learning/modeling tasks.

Another embodiment of the invention is a cyber testing system providing each tester virtual machine (VM) with one or more graphical user interfaces (GUI) which provide a one-stop platform for penetration testing activities (e.g. independent entity network security evaluations/assessments). Additionally, besides the Kali Linux command line terminal (and all the pre-loaded offensive security tools in Kali Linux), the testing system provides the tester with a web browser, a specialized task management dashboard for a team leader to assign activities to team members, a detailed session analysis tool for reporting and helping with automatic documentation of an tester's session including classification or clustering of engagements or parts of engagements, a dynamic area for team members to simultaneously collaborate, and an innovative cyber tool to automate the launching of attacks.

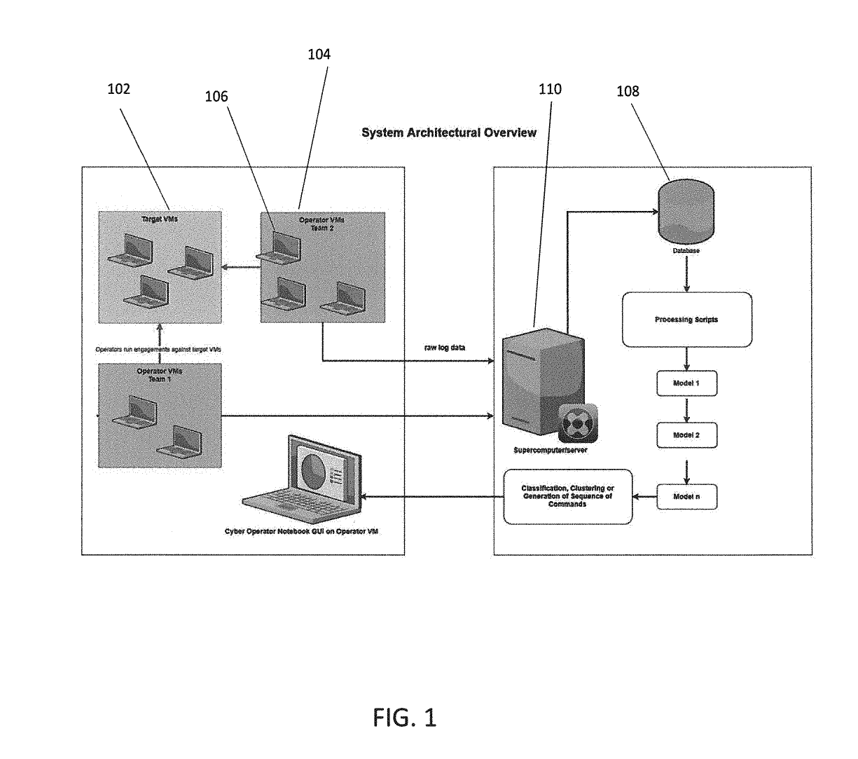

As depicted in FIG. 1, the penetration testing is performed relative to or upon a target or client system 102 of one or more computing devices. Of course, such a target system may have an infinite number of configurations of hardware and software. The penetration testing is implemented by a penetrating testing system 104 via one or more virtual machines (VMs) 106 or other physical hardware of the target system.

The penetration testers target the target system using one or more system-generated tester virtual machines (VMs) 106. These tester VMs 106 may be supported or implemented via one or more servers or the like of the tester system and are preferably instrumented to capture syslog, auditd, terminal commands, and network traffic (pcap) data as the penetration testers work. Regardless of how many instances of tester VMs are running and where they are being used, the raw log data from all of these VMs is captured and stored for processing (as described below) in order to provide the specific training session data needed to train models created by the disclosed system and methods which learn offensive security tradecraft. In one embodiment, the log data is stored in one or more databases 108 or memories associated with at least one processing server 110 of the tester system (which may be the same server(s) which support the tester VMs or may be one or more different servers). The server 110 may be, for example, a supercomputer which provides high performance data processing and includes a machine-learning function. Of course, the one or more servers or other computing devices of the tester system may have various configurations. In general, these devices include at least one processor or controller for executing machine-readable code or “software”, at least one memory for storing the machine-readable code, one or more communication interfaces, and one or more input/output devices.

One aspect of the invention is machine-readable code, such as stored in a memory associated with the testing system server, which is configured to implement the functionality/methods described below.

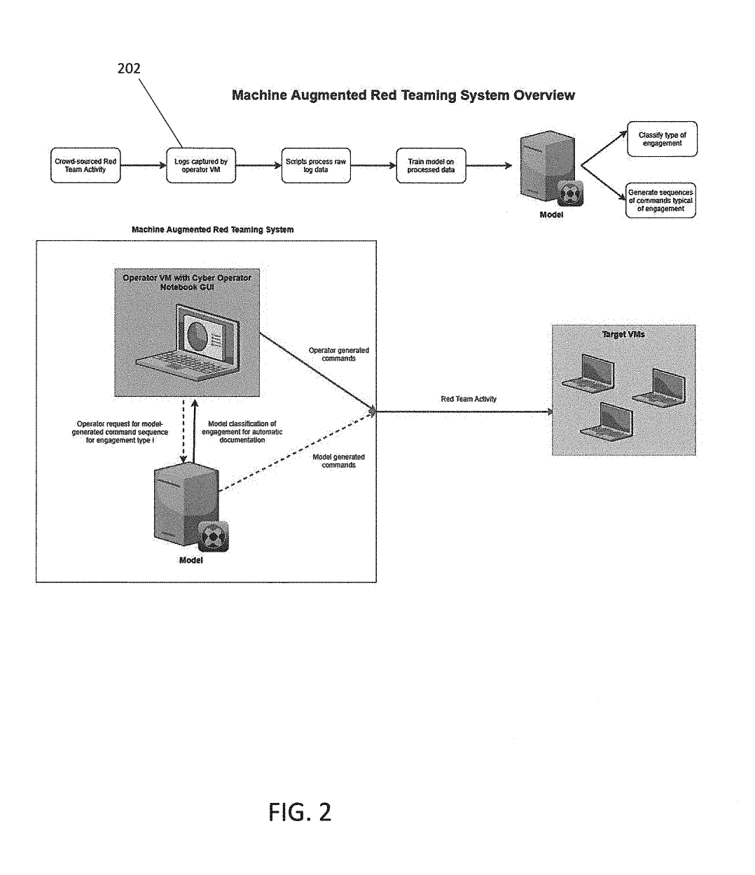

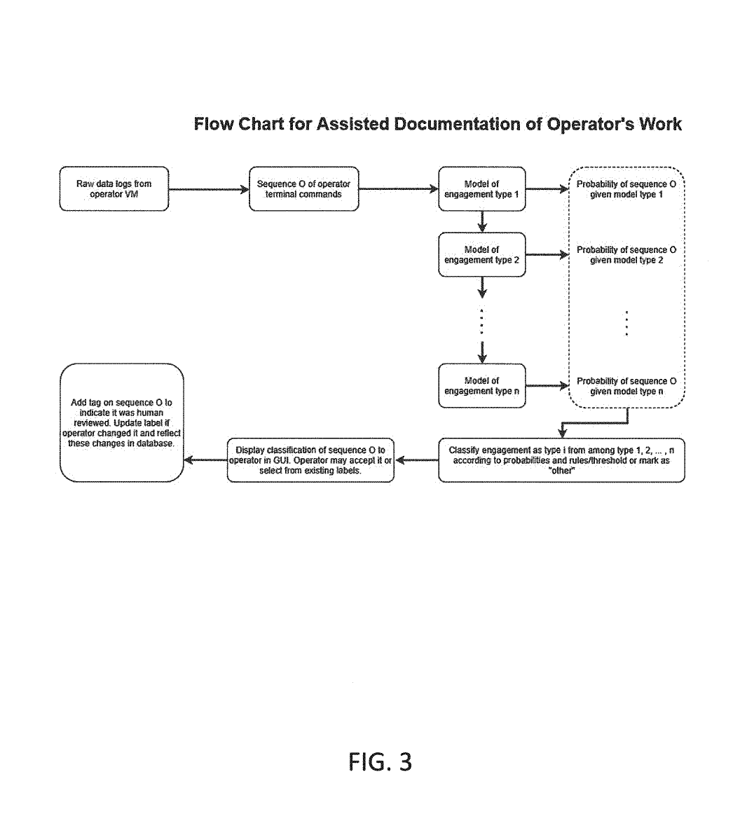

Aspects of a method in accordance with the invention will be described with reference to FIGS. 2 and 3. As illustrated in FIG. 2, the first step 202 in the process, before models of engagements (or parts of engagements) can be built, is to capture the log data generated as the penetration tester's work and provide labels for this data to be used by the penetration tester system's incorporated training models.

In building the training data set, a tester would work through some tasks, then navigate to a session analysis area of the GUI where he/she would document the work by providing tags or labels on the engagements or parts of engagements. Ideally, for building a starter training set, the tasks a tester performs would be relatively well-defined or structured, and the testers would be experienced and have similar level of proficiency. While the penetration tester system (including the tester VMs) may be configured to capture different types of raw data as described above, in one embodiment, the data may be focused on tester terminal commands, i.e. the commands typed in by a human tester. This data is preferably captured by the tester VMs and then stored in the one or more databases associated with the tester system server.

Sequences of such terminal commands (or variations on terminal commands, to be described later) are extracted from the logs, such as via the tester system server, and are used as representatives of tradecraft. The assumption in using terminal commands is that the sequence of commands that a tester issues during a particular type of engagement should be different (in general) from the sequences of commands typical of a non-tester (such as a non-Red Team user), or from the sequences of commands a tester with a different type of task would issue. Features like the types of programs, the order in which programs are used, the values of their parameters like arguments, flags, paths, etc., capture the tester's activities and are sufficient to characterize a type of engagement (or part of engagement) and differentiate one engagement from another.

While the preferred embodiment of the system and methods focuses on engagements which can be captured almost entirely with terminal commands, an alternative embodiment in the form of a subsystem or system modules may further be integrated into the preferred embodiment to handle other types of attacks, e.g. an application where the tester interacts with it using mouse clicks, rather than typing commands or an application which uses input not entirely captured through terminal commands.

As an example to further explain how the tester system operates, the first step 202 is to collect and label log data (sequences of tester terminal commands) used to train models appropriate for modeling sequences, e.g. Hidden Markov Models (HMMs) or recurrent neural networks (RNN) of the long short term memory (LSTM) variety models. The tester system server creates the models and then stores them. Once trained models are deployed (the models would reside on the tester system server, along with the raw data and the scripts to process that data), testers are aided in their training documentation process as follows: after a tester completes his/her work and navigates to the session analysis tool, the trained models automatically populate tags or labels on the engagements or parts of engagements, having learned from being trained on previous testers' data.

Additionally, the tester system incorporates a feedback system. If the models misclassified or were unable to classify the tester's work, the tester is able to manually change the tags or labels to improve accuracy (they could select from the known list of labels, or an “other” option, and this would update the label field). This feedback incorporated within the system may be used in a future round of re-training models to improve the models or to create new models.

In other embodiments, the tester system may accumulate some large number of engagement sequences which have been reviewed by a tester and classified as “other.” Based on a predetermined time or volume threshold, the system applies sequence clustering on such engagements.

For large enough/significant clusters, the tester system may train new models on the sequences in those clusters, then deploy the models to the training environment, adding to the current ones, within the larger system.

At intervals, the system tester may decide to review, using appropriate distance measures, the distance between elements within clusters, and the distance between clusters themselves to determine its current accuracy. If there is too much variation within one cluster, the tester system enables the tester to make an accuracy determination. If the system indicates two clusters are very similar, the tester is notified it may be more appropriate to combine the clusters.

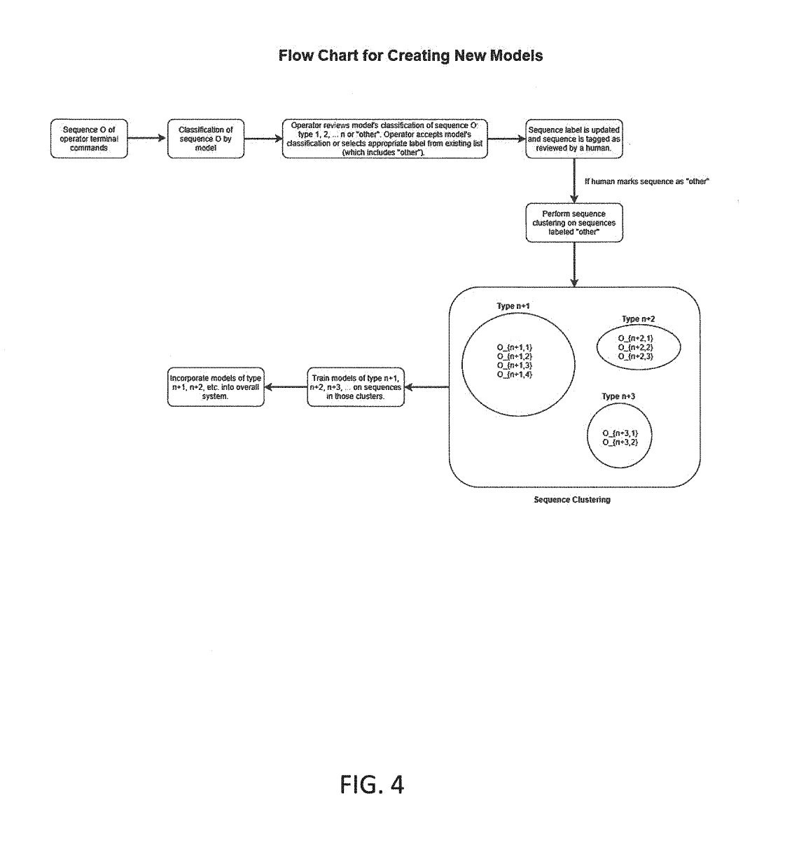

As depicted in FIG. 4, trained models within the tester system can also assist in the generation of attacks. Models like HMMs or LSTMs have the ability to generate sequences characteristic of the type of sequences they have been trained on.

For example, this would mean the models could generate sequences of tester terminal commands or variations on such commands which is one advantage of focusing on the terminal commands as the type of data the system uses to characterize engagements.

A new or inexperienced tester tasked with a known type of engagement could call upon the disclosed tester system for assistance, asking the model to generate a sequence of terminal commands for a given type of engagement as an example.

Over time with labeled data from other testers, the model used by the system will learn the most probable sequence of commands for a given type of engagement and could display it for the tester who is learning. This approach is an advantage over having to manually browse through many specific examples, and subsequent trainings of the models would allow for changes in the tradecraft.

Further embodiments of the tester system provide the ability to execute a generated sequence of commands automatically incorporating a model to produce a more generalized or templated version of commands, requiring some tester input, such as inputting a target IP address, or flags.

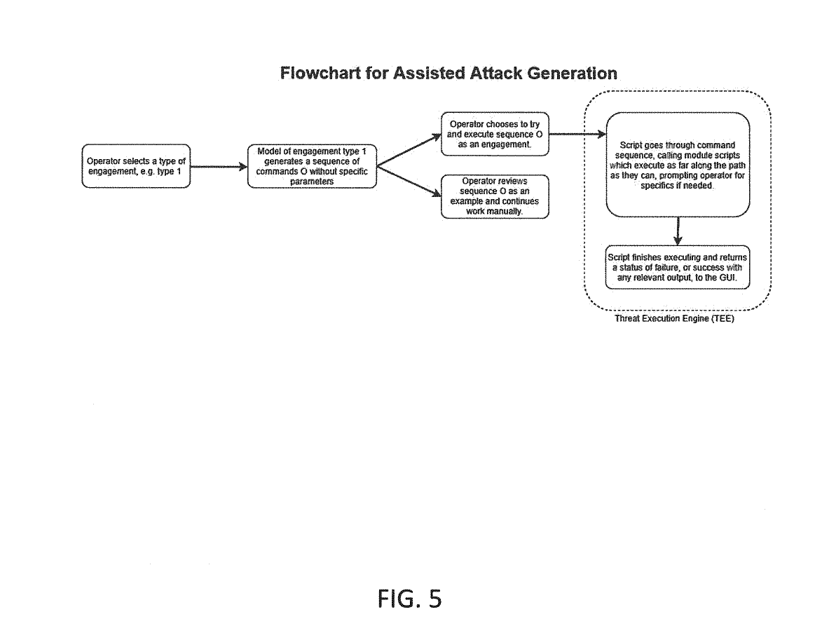

To this end, for suitable engagements, the tester system prompts the tester when needed, but otherwise uses the sequence of commands generated by the model to call modular scripts which can take the tester's specific input, run the program/system call in the command generated by the model, record its output, and use that output as potential input for the next script which can execute the next program in the generated sequence of commands, thereby semi-automating the generation of attacks as shown in FIG. 5.

Initial Data Capture and Processing

The raw log data, such as auditd data containing terminal commands, is captured by the tester system and parsed from the raw format to a format which can be used to create tables for further analysis or modeling. In the disclosed invention, sequences of full user commands (including parameters such as flags and arguments) which a tester issues during an engagement are extracted by the system.

On the tester VMs, auditd is configured by the system such that terminal commands and commands from within other applications such as Metasploit are available. This is an important feature of the system, as a full sequence of user commands cannot be obtained if logging is not enabled and such commands are not integrated with the Kali terminal commands.

One example of the system's initial extract-transform-load (ETL) process is as follows:

1. Audit raw data is in key-value pairs written into the auditd log.

2. Data parsed into an interchange.

3. Data posted to where data scientists can query the data and write scripts to further process the data into the format they need and do feature engineering for modeling.

Details of the Model within the System

The system model uses the captured auditd data, which contains the terminal commands.

The system further collects data from testers who have run through some training engagements of a certain type and have labeled their sessions as such and that these labels appear as a field in the data. The system uses the labeled data to train the model.

The summarized system process starting from parsed auditd data to information that can help a tester is as follows:

Obtain processed auditd data from database.
a. Necessary fields: labeled type of engagement, session id, timestamp, terminal command.

Scripts for post-processing and feature engineering.
a. Create separate tables for each type of engagement. A model will be built for each type of engagement.
b. Create the same tables with possible variations on the terminal commands:
   i. Omit argument and flags (only leave the program).
   ii. Use templates with placeholders for arguments and flags.
   iii. Cluster commands and use a selected cluster representative instead of the full command.
   iv. Omit certain commands.

Build model
a. For each engagement, for any of the above variations on terminal commands, split the data on sessions into training/test.
b. Specify initialization parameters for the model.
c. For each engagement, train model on command line sequences for the set of sessions in the training set.
d. Evaluate model.
e. Iterate process with variations on input data, initialization parameters, etc. to determine best parameters and input structure of data.

Deploy model
a. Fix a version of a trained model (i.e. fix the satisfactory parameters) for each engagement type to deploy. Models can be trained and deployed at intervals to incorporate more training data as more labeled data is available.

Incorporate trained model into the overall tester platform. Aid less experienced testers via the GUI on the tester VM.
a. After a tester completes an engagement, the data is processed as above, minus the label, and run through the models for classification.
b. If a less experienced tester wants to perform a certain type of engagement for which we already had labeled data, the trained model can generate a sequence of commands (or variation on commands) it has learned is typical of this type of engagement.

Receive feedback and provide more model supervision for improving the model.

In accordance with other aspects of the invention, embodiments of systems and methods of the invention transform lines of raw audit records into graphs (having vertices and edges). This representation of the data then allows querying and traversing of the graphs to compute features which can then be used in a model to classify tools that the testers (i.e. pen testers) are using. The predictive model uses the data to compute new features which the predictive model uses to classify/label the type of tool(s) a pen tester is using during an engagement. For example, the predictive model could classify the tool(s) into categories/labels such as: information gathering, sniffing and spoofing, vulnerability analysis, password cracking, etc. as further explained below.

The penetration testers target the target system 102 using one or more system-generated tester virtual machines (VMs) 106. These tester VMs 106 may be supported or implemented via one or more servers or the like of the tester system and are preferably instrumented to capture syslog, audit records, terminal commands, and network traffic (pcap) data as the penetration testers work. Regardless of how many instances of tester VMs are running and where they are being used, the raw log data from all of these VMs is captured and stored for processing (as described below) in order to provide the specific training session data needed to classify the type of tools used by a tester in the disclosed system and methods. In one embodiment, the log data is stored in one or more databases 108 or memories associated with at least one processing server 110 of the tester system (which may be the same server(s) which supports the tester VMs or may be one or more different servers). The server may be, for example, a supercomputer which provides high performance data processing and includes a machine-learning function. Of course, the one or more servers or other computing devices of the tester system may have various configurations. In general, these devices include at least one processor or controller for executing machine-readable code or “software”, at least one memory for storing the machine-readable code, one or more communication interfaces, and one or more input/output devices.

One aspect of the invention is machine-readable code, such as stored in a memory associated with the testing system server, which is configured to implement the functionality/methods described below.

While the penetration tester system (including the tester VMs) may be configured to capture different types of raw data (log data) as described above, in one embodiment, the data may be focused on tester terminal commands, i.e. the commands typed in by a human tester. This data is preferably captured by the tester VMs 106 and then stored in the one or more databases associated with the tester system server 108.

While the preferred embodiments of the system and methods focuses on engagements which can be captured almost entirely with terminal commands, an alternative embodiment in the form of a subsystem or system modules may further be integrated into the preferred embodiment to handle other types of attacks, e.g. an application where the tester interacts with it using mouse clicks, rather than typing commands or an application which uses input not entirely captured through terminal commands.

The audit records, such as auditd containing terminal commands, is captured by the tester system. The raw data is merged according to its type and the audit bundle in which it arrives. The audit records capture operating system calls in key-value format. Records generated by the same audit event are bundled together; membership to the same audit event is indicated by sharing a time stamp and audit ID. Then, relationships between events that precede and succeed the event in question are created.

For example, the following are three audit records that comprise a single audit event, and become merged together. Each audit record consists of several fields separated by a comma and represented as key value pairs. All audit records start with the type field, which determines the other fields the record contains. Audit records also contain a msg field, which has a timestamp and audit ID. Having the same timestamp and audit ID indicates the audit records are from the same system event, and thus these will be merged together.

type=SYSCALL msg=audit(1364481363.243:24287): arch=c000003e syscall=2 success=no
exit=−13 a0=7fffd19c5592 a1=0 a2=7fffd19c4b50 a3=a items=1 ppid=2686 pid=3538 auid=500
uid=500 gid=500 euid=500 suid=500 fsuid=500 egid=500 sgid=500 fsgid=500 tty=pts0 ses=1
comm=″cat″ exe=″/bin/cat″ subj=unconfined_u:unconfined_r:unconfined_t:s0-s0:c0.c1023
key=″sshd_config″
type=CWD msg=audit(1364481363.243:24287): cwd=″/home/shadowman″
type=PATH msg=audit(1364481363.243:24287): item=0 name=″/etc/ssh/sshd_config″
inode=409248 dev=fd:00 mode=0100600 ouid=0 ogid=0 rdev=00:00
obj=system_u:object_r:etc_t:s0

Embodiments of the systems and methods of the invention then use a script which can be run by a processor in computer 110, which script is configured to parse the merged audit records and transform the parsed data into a graph data model, which can be stored into a graph database. Transformation to a graph model consists first of identifying the actors, actions, and resources in these merged audit records; and secondly of associating properties to these actors, actions, and resources. Actors take actions that cause events to happen, and actors may utilize resources. In a graph data model, actors and resources are nodes; actions are edges between these nodes. Actions connect an actor to another actor or resource (but never one resource to another). Additionally, these nodes and edges have properties associated with them. Since the audit records are deterministically emitted by auditd according to the system call that generated them, we can create another deterministic methodology for converting audit records into the actors, actions, and resources of interest. This deterministic methodology is informed by the domain and problem at hand; all or less of the audit record fields may be included in the transformation to satisfy the processing speed and space constraints of the system. The methodology must be defined for each audit record type that is of interest.

The following is an example of four audit records, merged together as described above:

type=SYSCALL msg=audit(1512759901.845:3066172): arch=c000003e syscall=42 success=no
exit=−2 a0=3 a1=7ffd451f6fa0 a2=6e a3=6 items=1 ppid=28235 pid=28236 auid=0 uid=0 gid=0
euid=0 suid=0 fsuid=0 egid=0 sgid=0 fsgid=0 tty=(none) ses=22966 comm=″cron″
exe=″/usr/sbin/cron″ key=″network″ type=SOCKADDR msg=audit(1512759901.845:3066172):
saddr=01002F7661722F72756E2F6E7363642F736F636B65740000B3C3B10200000000190000
0000000000F0701F45FD7F0000C8FF2F7F627F0000802D2F7F627F000014701F45FD7F0000
E0701F45FD7F0000C830CC7F627F00000A000000000000000000000000000000909DBD0100
00
type=CWD msg=audit(1512759901.845:3066172): cwd=″/var/spool/cron″
type=PATH msg=audit(1512759901.845:3066172): item=0 name=″/var/run/nscd/socket″
nametype=UNKNOWN

We can identify three actors in this example: a command and executable indicated by the comm and exe fields on the SYSCALL record; the process invoked by this command, which is indicated by the pid field on the SYSCALL record; and the parent process of this command, indicated by the ppid field on the SYSCALL record. We can identify two resources in this example: a socket, indicated by the saddr field on the SOCKADDR record; and a working directory indicated by the cwd field on the CWD record.

The actions connecting these actors and resources yield the following edges between nodes:
a. The command actor to the process actor: the command has invoked this process
b. The process actor to the parent process actor: there is a parent-child relationship
c. The process actor to the working directory resource: this resource was used when the process invoked the system call triggering the audit event
d. The process actor to the socket resource: the process created a socket to connect to Once the actors, resources, and actions have been identified, properties from the audit records are attached to these. Properties that are intrinsically part of the actor or resource become properties on that respective node; properties that are mutable or related to the action become properties on that respective edge. Properties that are not of interest may be ignored in this transformation step.

The saddr field of the SOCKETADDR audit record defines the address of the socket resource; a different saddr would indicate a separate resource. Thus, saddr is intrinsically part of a socket resource and becomes a property of the socket resource node. The same holds for the cwd field of the CWD audit record: it defines the resource and thus becomes a property of the working directory resource node. Likewise, the comm and exe fields are properties of the command actor node; the pid field is a property of the process actor node; the ppid field is a property of the parent process actor node.

The exit and success fields pertain to a single invocation and thus are properties of the action edge connecting the command actor and the process actor.

As more audit records are processed, actors, resources and actions are added to the graph. Actors and resources will occur in multiple audit record events and thus appear in multiple merged audit records. An actor or resource that appears in multiple audit record events is represented by a single node in the graph.

In the case of a system that supports testers on multiple computers, actors and resources from different computers are never the same. That is, a working directory resource of “/var/spool/cron” from machine A is a different resource node from an audit event with that same working directory but generated by machine B. Thus, the host computer is a defining property of any resource or actor in a collection system with multiple computers.

An actor exists within a temporal context. Operating systems define processes by their process IDs, yet these process IDs are reused over time. As new processes are created on the computer, they are assigned sequential, increasing process IDs. When the processlD reaches a limit defined by the computer, the assigned process IDs wraps around to 1. Further, the process audit records include the ses field, which defines the session from which the process was invoked. These behaviors of the computer lead to the following situations in which a single process ID refers to a different actor:
a. The computer host differs
b. The ses field of the audit record differs
c. We have seen the process IDs on the test computer wrap around since the last audit event that included the process ID in consideration
d. We have seen a process termination audit event for the process actor
e. The process actor has a different parent process ID from that of the process ID under consideration

The context of Command actors includes their associated process actor. An audit event with the same command but a different process actor refers to a different command actor.

In a simplified case, two resources are the same if they have the same properties and are from the same computer that generated audit event.

Temporal context can be added to resources as well. For example, we may wish to model that socket resources can change over time. We should then define the parameters in which a socket resource is considered consistent—e.g., we expect any socket address observed within the same day to refer to the same resource. Under this definition, then a socket resource is a new node in the graph is its audit record timestamp is more than 24 hours away from a socket resource node with the same address and host.

When merged audit records refer to actors and resources already in the graph, new edges containing the properties of the associated actions are created between the existing nodes. The transformation process to generate these edges is the same as if these were never-before-seen actors and resources.

Properties may be added to actor nodes as more audit records are processed. This may be because more event information is available later, e.g., an audit record for a process ending would at a termination timestamp property to the process actor.

The merged audit records may not be processed in the order in which they were generated by the operating system if the merged audit records are processed in a distributed or multithreaded environment.

The command actor nodes are classified into a category of penetration testing tools. The tool type category could be one or more of the following:
a. Information Gathering
b. Vulnerability Analysis
c. Web Applications
d. Exploitation Tools
e. Wireless Attacks
f. Stress Testing
g. Forensics Tools
h. Sniffing & Spoofing
i. Password Attacks
j. Maintaining Access
k. Reverse Engineering
l. Hardware Hacking
m. Reporting Tools

The data represented in the graph model is transformed into a feature vector to be used as input to the predictive model that classifies the penetration testing tool. The features generated may change in order to improve model performance. Features that are not useful in one setting may no longer be calculated. If more data is able to be collected, then new features may be based on that new data. The feature vector contains information from the following feature family categories:
Properties and information derived from properties on the command actor node
Properties and information derived from properties of edges on the command actor node
Properties and information derived from the actions the actor was involved in
Properties and information derived from immediately adjacent nodes
Properties and information derived from reachable nodes (i.e., nodes that are not immediately adjacent to the command node but have some path between themselves and the command node)
Properties and information derived from commands run by the operator has run leading up to this command
Properties and information derived from commands run by the operator after running this command
Properties and information derived from properties of the session
Properties and information derived from properties of the session of the operator across sessions

Examples of the features are from the above feature families:
1. Created from properties of the command node.
2. Created from properties of edges of the command node.
3. Created from properties of nodes directly connected to the command node (I.e., immediately adjacent nodes)
4. Created from properties of reachable nodes (I.e., nodes that are not adjacent to the command node but have some path between themselves and the command node)
5. Created from prior commands the operator ran
6. Created from commands the operator after running this command.
7. Created from properties of the session
8. Created from properties of the operator across sessions

### Example Features:

These are from the families above and are described/calculated from the nmap command in the included examples.

1. Properties of the command node:
a. Command_name: nmap

2. Properties of edges of the command node:
a. Number of incoming edges: 1
b. Syscall of incoming edge: 59
c. argument count: 4
d. IP in argument list: true

3. Properties of adjacent nodes:
a. Duration of parent process: (1534261078.751-1534261078.687)=0.064
b. Number of other commands attached to parent process: 0

4. Properties of reachable nodes:
a. Number of socket nodes attached to parent Process: 14

5. Properties of prior commands from operator:
a. Command name of prior executed command: ping
b. Is prior command same as this command: false
c. Predicted Command category of prior executed command: (assume we predicted) scanning
d. Number of prior commands in this session: 1

6. Properties of future commands:
a. Number of future commands in this session: 1
b. Is next command same as this command: false
c. Is this command run again in session: false

7. Properties of this session:
a. Duration of session: (1534261115.433-1534260941.644)=173.789
b. Times command is run in session: 1
   This example feature vector is:

### [Nmap, 1, 59, 4, True, 0.064, 0, 14, Ping, False, Scanning, 1, 1, False, False, 173.789, 1]

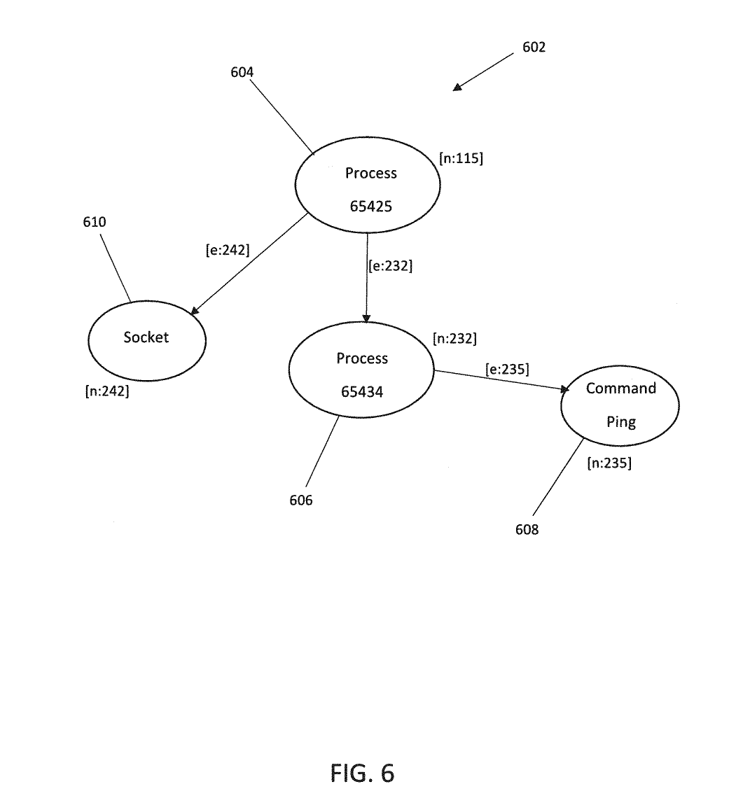

FIG. 6 illustrates a graph 602 created from the above example. In this example, the systems and methods of the embodiments of the invention utilize a script which parses the merged audit records and transforms the parsed data into a graph 602. The script identifies a command and executable 608 indicated by the comm and exe fields on the SYSCALL record (ping command), which is created in the graph as node [n:235]; the process 606 invoked by this command (process 65434), which is indicated by the pid field on the SYSCALL record and is created in the graph as node [n:232]; and the parent process 604 of this command (process 65425), indicated by the ppid field on the SYSCALL record, which is created in the graph as node [n:115]. The script also identifies a resources in this example: a socket, indicated by the saddr field on the SOCKADDR record, which the script creates in the graph 602 as socket 610 (node [n:242]).

The script further identifies actions connecting the nodes to yield the edges: edge [e:232] between nodes [n:115] and [n:232], edge [e:235] between nodes [n:232] and [n:235], and edge [e:242] between nodes [n:115] and [n:242]. Then the script identifies properties that it associates with each edge and node as follows, which may be included in graph 602, although not shown in FIG. 6:
To edge [e:235]:
   timestamp (1534260947.301)
   syscall
   success
   exit
   auid, uid, euid, suid, fsuid
   gid, egid, sgid, fsgid
   execue.arge
   execue.argo
   execue.arg1
   paths name
To node [n:235]:
   host
   session-id
   comm
   exe
To edge [e:242]:
   timestamp
   syscall
   success
   exit
   a0-a3
To node [n:242]:
   saddr
   host
   session-id
To edge [e:232]:
   timestamp (1534260947.301)
   type: cloned
   syscall
   success
   a0-a3
To node [n:232]:
   host
   session-id
   comm

Additional socket nodes [n:246] and [n:250] (although not shown in FIG. 6 for brevity) with corresponding edges are also created in the same way by the script from audit blocks.

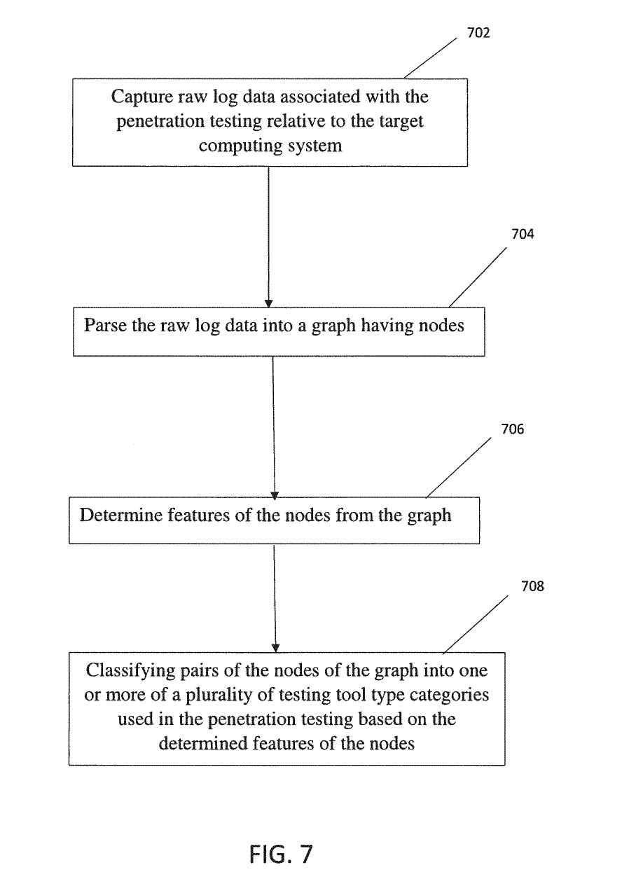

FIG. 7 illustrates a flowchart of embodiments of the invention including the steps explained in more detail above. In step 702, raw log data associated with the penetration testing relative to the target computing system is captured. In step 704, the raw log data is parsed into a graph having nodes.

In step 706, features of the nodes are determined from the graph. In step 708 pairs of the nodes of the graph are classified into one or more of a plurality of testing tool type categories used in the penetration testing based on the determined features of the nodes.

The systems and methods of the embodiments of the invention provide automatic classification of the unknown type of tool used by a penetration tester. This is especially useful when the penetration tester is using a non-standard or custom penetration tool, because the system can still classify even such a non-standard penetration tool.

It will be understood that the above described arrangements systems and methods are merely illustrative of applications of the principles of this invention and many other embodiments and modifications may be made without departing from the spirit and scope of the invention as defined in the claims.

What is claimed is:

1. A computer-implemented process of classifying unknown cybersecurity tools used in penetration testing based upon monitored penetration testing of a target computing system using at least one penetration testing tool, comprising:
capturing raw log data associated with the penetration testing relative to the target computing system;
parsing the raw log data into a graph having nodes, each node corresponding to an actor or a resource in the raw log data;
connecting the nodes with edges, each of the edges corresponding to an action of the actor or resource in the raw log data;
determining features of the nodes and edges from the graph; and
classifying the nodes of the graph into one or more of a plurality of testing tool type categories used in the penetration testing based on the determined features of the nodes and the edges.

2. The process of claim 1, wherein capturing raw log data associated with the penetration testing comprises capturing auditd records containing terminal commands.

3. The process of claim 1, further comprising determining one or more properties of the actors, the resources and the actions from the raw log data.

4. The process of claim 3, further comprising associating the determined properties of the actors and the resources with a corresponding ones of the nodes.

5. The process of claim 3, further comprising associating the determined properties of the actions with a corresponding ones of the edges.

6. The process of claim 4, wherein determining features of the nodes from the graph comprises creating a feature vector from the each of the determined properties.

7. The process of claim 6, wherein the features contain information from feature family categories including properties and information derived from properties of the nodes and edges.

8. The process of claim 1, wherein the plurality of tool type categories includes at least one of: information gathering, sniffing and spoofing, web applications, vulnerability analysis, exploitation tools, stress testing, forensic tools, reporting tools, maintaining access, wireless attacks, reverse engineering, hardware hacking and password cracking.

9. A system for classifying unknown cybersecurity tools used in penetration testing based upon monitored penetration testing of a target computing system using at least one penetration testing tool, comprising:
a database configured to store raw log data associated with the penetration testing relative to the target computing system;
a processor configured to:
parse the raw log data into a graph having nodes, each node corresponding to an actor or a resource in the raw log data;
connect the nodes with edges, each of the edges corresponding to an action of the actor or resource in the raw log data;
determine features of the nodes and edges from the graph; and
classify the nodes of the graph into one or more of a plurality of testing tool type categories used in the penetration testing based on the determined features of the nodes and the edges.

10. The system according to claim 9, wherein the processor is further configured to determine one or more properties of the actors, the resources and the actions from the raw log data, associate the determined properties of the actors and the resources with a corresponding ones of the nodes, and associate the determined properties of the actions with a corresponding ones of the edges.

11. The system according to claim 10, wherein determining features of the nodes and edges from the graph comprises creating a feature vector from each of the determined properties.

12. The system according to claim 11, wherein the features contain information from feature family categories including properties and information derived from properties of the nodes and edges.

13. The system according to claim 9, wherein the plurality of tool type categories includes at least one of: information gathering, sniffing and spoofing, web applications, vulnerability analysis, exploitation tools, stress testing, forensic tools, reporting tools, maintaining access, wireless attacks, reverse engineering, hardware hacking and password cracking.

14. A computer-implemented process for automating aspects of cyber penetration testing comprising the steps of:
capturing raw log data associated with penetration testing operations performed by a penetration tester on a virtual machine relative to a target computing system;
storing said raw log data in one or more databases of a testing system;
labelling said raw log data with one or more engagement-relevant labels;
extracting, via a processor of said testing system, terminal commands from said raw log data; and
training one or more penetration testing models based upon said terminal commands, said penetrating testing models configured, when executed, to generate a plurality of command line sequences to implement one or more penetration testing engagements.

15. The process of claim 14, wherein the captured raw log data is in key-value pairs written into an audited log.

16. The process of claim 14, wherein the captured log data includes at least one of labeled type of engagement, session id, timestamp, and terminal command.

17. The process of claim 14, further comprising creating separate tables of the log data for each of a plurality of types of engagement, and a separate penetration testing model for each type of engagement.

18. The process of claim 14, wherein training the one or more penetration testing models comprises specifying initialization parameters for the model.

19. The process of claim 18, further comprising training the model on the terminal commands for a set of sessions.

20. The process of claim 19, further comprising iterating the previous steps to further train the model.
